(19) United States
(12) Patent Application Publication
(10) Pub. No.: US 2013/0247122 A1
(43) Pub. Date: Sep. 19, 2013

(54) METHOD, SYSTEM AND MOBILE TERMINAL FOR SWITCHING WORKING STATE OF MOBILE TERMINAL

(71) Applicant: Ming Yuan, Shenzhen (CN)

(72) Inventor: Ming Yuan, Shenzhen (CN)

(21) Appl. No.: 13/989,672

(22) PCT Filed: Feb. 28, 2011
(86) PCT No.: PCT/CN2011/071394

§ 371 Date: May 24, 2013

(30) Foreign Application Priority Data
Nov. 26, 2010 (CN) 201010561755.0

(51) Int. Cl. H04N 5/44

(52) U.S. Cl. CPC H04N 5/4403
USPC 725/110

(57) ABSTRACT

A method for switching the working state of a mobile terminal comprises that: the mobile terminal detects the swinging state of a user; when the swinging state matches a predetermined rule, the mobile terminal sends a playing instruction used for the current online playing video to a digital television receiving terminal, and switches the working state to a remote controller state; and the digital television receiving terminal obtains the playing video to play according to the playing instruction. The present invention conveniently switches the mobile terminal to the remote controller for users to use, after the digital television receiving terminal has continued to play the online video being played by the mobile terminal, which is convenient to the users and improves the experience of the users.

This application claims the benefit of priority to CHINA Patent Application No. 201010561755.0 filed with the Chinese Patent Office on Nov. 26, 2010 and entitled “MOBILE TERMINAL AND A METHOD FOR SWITCHING WORKING STATE OF THE MOBILE TERMINAL”, the contents of which are incorporated herein by reference in their entirety.

### FIELD OF THE INVENTION

The invention relates to control technology filed, and particularly, to a method, a system and a mobile terminal for switching working state of the mobile terminal.

### BACKGROUND OF THE INVENTION

With the continuous development of communication technology, more and more applications can connect with the mobile network, the Internet, and the radio and television network, and a merging of the three networks gradually comes true. In this background, terminals in the three networks have more and more common functions, for example, more and more functions of cellular phones and personal computers are integrated into a set-top box. On the other hand, with the development of mobile Internet, online video displayed on the cellular phone become more and more popular. However, screen size of the cell phones is limited to meet the portability requirement of the cell phones. As such, the users normally could not obtain a good experience when viewing the online video by the cell phones as the limited screen size. Therefore, users tend to prefer to watch the interested video on a digital television receiving terminal.

If the users find an interested online video on the cellular phone and want to watch the interested video by the digital television receiving terminal, they can control the cellular phone to send a playing instruction used for the current online playing video to the digital television receiving terminal, to enable the digital television receiving terminal to play the current online playing video according to the playing instruction. Subsequent play control is carried out by a remote control of the digital television receiving terminal.

In practical use, when the digital television receiving terminal starts to play the online video, the users need to control the digital television receiving terminal with the help of a remote controller. That means when the remote controller is not around, the users have to find the remote controller to control the digital television receiving terminal, which is inconvenient to the users.

### SUMMARY OF THE INVENTION

The technical problem to be solved by the invention is: to provide a mobile terminal and a method for switching working state of the mobile terminal, which can easy to switch the mobile terminal to a remote controller when a digital television receiving terminal continue to play a online video being played by the mobile terminal.

To solve the problem of the present invention, the invention discloses an interaction method between a digital television reception terminal and a mobile terminal.

To solve the problem of the invention, the invention discloses a method for switching working state of a mobile terminal, wherein the method includes:

the mobile terminal detects a swinging state of a user;

the mobile terminal sends a playing instruction used for a current online video to a digital television receiving terminal and switches a current working state of the mobile terminal to a remote controller state when the swinging state matches a predetermined rule; and

the digital television receiving terminal acquiring the online video to play according to the playing instruction.

In addition, the step that the mobile terminal detects the swinging state of a user also includes:

the mobile terminal detects a swinging direction and/or a swinging amplitude of the user.

In addition, the step that the mobile terminal switches the current working state of the mobile terminal to the remote controller state also includes:

the mobile terminal switches the current working state of the mobile terminal to the remote controller state when the swinging direction and/or the swinging amplitude of the user match the predetermined rule;

In addition, the step of that the mobile terminal switches the current working state of the mobile terminal to the remote controller state also includes:

the mobile terminal transfers a currently running program into the background or stopping the currently running program and invoking a remote controller program to provide a virtual remote controller interface when the swinging state matches the predetermined rule.

In addition, the step that the mobile terminal switches the current working state of the mobile terminal to the remote controller state also includes:

the mobile terminal switches an input mode of a physical keyboard to an input mode of a remote controller when the swinging state matches the predetermined rule.

In addition, the method further includes the following steps after the digital television receiving terminal acquires the online video to play according to the playing instruction:

the mobile terminal acquires a keyboard instruction of the user;

the mobile terminal converts the keyboard instruction to a corresponding remote controlling instruction according to the predetermined rule; and

the mobile terminal transmits the remote controlling instruction.

In addition, the step that the mobile terminal transmits the remote controlling instruction also comprises:

the mobile terminal transmitting the remote controlling instruction via the infrared and/or Bluetooth, and/or Wi-Fi.

In addition, the method further includes the following step after the digital television receiving terminal acquires the online video to play according to the playing instruction:

the digital television receiving terminal executes the remote controlling instruction.

To solve the problem of the invention, the invention discloses a mobile terminal, which includes:

a detecting module configured to detect a swinging state of a user; and

a processing module configured to sends a playing instruction corresponding to a current online video to a digital television receiving terminal when the swinging state matches a predetermined rule and switching a current working state to the remote controller state.

In addition, the detecting module is also configured to detect a swinging direction and/or a swinging amplitude.

In addition, the processing module is also configured to switch the current working state to the remote controller state when the swinging direction and/or the swinging amplitude match the predetermined rule.

In addition, the processing module is configured to transfer a currently running program into the background or stop the currently running program and invokes a remote controller program to provide a virtual remote controller interface when the swinging state matches the predetermined rule.

In addition, the processing module is configured to switch an input mode of a physical keyboard to an input mode of a remote controller when the swinging state matches the predetermined rule.

In addition, the mobile terminal further includes:

an acquiring module configured to acquire a keyboard instruction input by the user when the swinging state matches the predetermined rule;

a converting module configured to converts the keyboard instruction to a corresponding remote controlling instruction according to the predetermined rule; and

a transmitting module configured to transmits the remote controlling instruction.

In addition, the transmitting module is configured to transmit the remote controlling instruction via the infrared and/or Bluetooth, and/or Wi-Fi.

Comparing with a prior art, The present invention has the following advantages: the invention transforms the mobile terminal to the remote controller when the digital television receiving terminal has continued to play the current video being played on the mobile terminal, which is convenient to the user and improves the experience of the user.

### BRIEF DESCRIPTION OF THE DRAWINGS

FIG. 1 a flowchart of an embodiment of a method for switching working state of a mobile terminal provided in the present invention;

FIG. 2 is a structural schematic diagram of an embodiment of a mobile terminal provided in the present invention.

### DETAILED DESCRIPTION OF ILLUSTRATED EMBODIMENTS

Embodiments of the present invention provide a mobile terminal and a method for switching working state of the mobile terminal, which can easily switch the mobile terminal to a remote controller for the user after the digital television receiving terminal continue to play the currently online video being played on the mobile terminal.

To further clarify the objectives, technical schemes, and advantages of the present invention, the following sections offer a detailed description of the present invention in combination with the embodiments and accompanying drawings. It should be understood that the embodiments described herein are only a part of, but not all of the embodiments of the present invention. In view of the embodiments described herein, any other embodiment obtained by the person skilled in the field without offering creative effort is included in a scope claimed by the present invention.

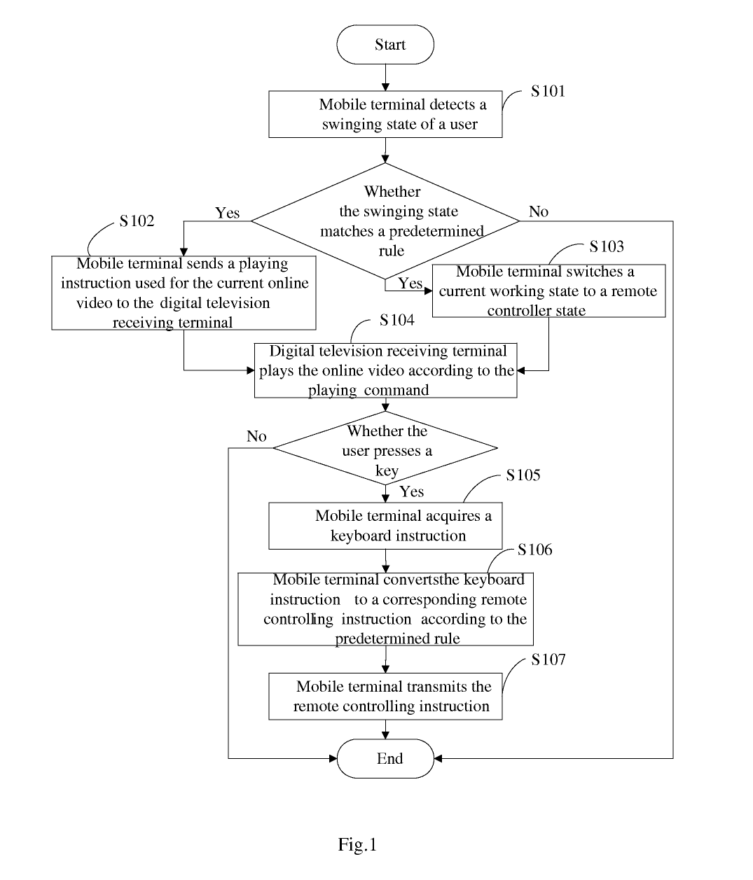

Referring to FIG. 1, FIG. 1 is a flowchart of an embodiment of a method for switching working state of a mobile terminal provided in the present invention.

In the embodiment of the present invention, the mobile terminal includes a vector sensor. The vector sensor may be a gyroscope and/or a gravity sensor, etc.

Step S101, the mobile terminal detects a swinging state of a user;

the mobile terminal detects the swinging state of the user via the built-in vector sensor, and the swinging state can be a swinging direction and/or a swinging amplitude.

Step S102, when the swinging state matches a predetermined rule, the mobile terminal sends a playing instruction used for the current online playing video to the digital television receiving terminal;

when the swinging direction and/or the swinging amplitude matches the predetermined rule, the mobile terminal measures an acceleration of the swinging via the gyroscope and/or the gravity sensor. When the acceleration exceeds a predetermined threshold value, the video is switched to be played by the digital television receiving terminal instead of the mobile terminal. That is, the swinging action of the user needs to meet preset requirement to avoid misoperation. When the swinging action of the user meets the preset requirement, the mobile terminal invokes a preset swinging control instruction.

Step S103, the mobile terminal switches the working state to a remote controller state;

when the swinging direction and/or the swinging amplitude of the user matches the predetermined rule, the working state of the mobile terminal is switched to the remote controller state; that is, when the swinging state of the user matches the predetermined rule, the mobile terminal determines that the user is inputting a switching instruction of the working state. The mobile terminal can measure the acceleration of the user's swinging action via the gyroscope and/or the gravity sensor, and determine that the user needs to input the switching instruction of the working state when the acceleration exceeds the predetermined threshold value.

For example, if the predetermined rule is the swinging actions which is swinging toward left first and then right, when the swinging direction of the user conforms to the swinging actions, the mobile terminal determines that the user needs to switch the working state of the mobile terminal; it's should be understood that the predetermined rule can be fixed in advance or be reset in advance by the user, the predetermined rule also can be a reset swinging amplitude of the swinging actions. When the user needs to switch the working state of the mobile terminal, then the working state is switched to the remote controller state.

Furthermore, when the mobile terminal includes a touch screen, the mobile terminal can transfer the currently running program to the background or stop the currently running program according the predetermined rule, and invoke the remote controller program to provide a virtual remote controller interface. In this way, the user can operate a remote controller by clicking the buttons of the virtual remote controller interface on the touch screen. When the mobile terminal includes a physical keyboard, the mobile terminal switches an input mode of the physical keyboard to an input mode of the remote controller, so that when the user presses one of the buttons in the keyboard, the mobile terminal can convert a meaning of the pressed button to the corresponding remote controlling instruction according to the predetermined rule.

What is needed to mention is the Step S103 can be simultaneously executed with the Step S102, and also can be executed after the Step S102.

Step S104, the digital television receiving terminal acquires the online playing video to play according the playing instruction.

When the digital television receiving terminal receives the playing instruction, the digital television receiving terminal acquires the online playing video to play.

Furthermore, when the digital television receiving terminal acquires the online playing video to play according to the playing instruction, the following steps can be employed when the user executes the remote operation via the mobile terminal:

step S105, acquiring a key instruction;

when the mobile terminal is switched to the remote controller state, the user can press the corresponding key to execute the remote operation, and the mobile terminal will obtain the key instruction.

Step S106, converting the key instruction to the corresponding remote controlling instruction according to the predetermined rule;

when the mobile terminal acquires the key instruction input by the user, then the key instruction is converted to the corresponding remote controlling instruction according to the predetermined rule.

Step S107, transmitting the remote controlling instruction.

The mobile terminal can transmit the remote controlling instruction via the infrared and/or Bluetooth, and/or Wi-Fi. The digital television receiving terminal executes a corresponding processing according to the remote controlling instruction when receives the remote controlling instruction.

The embodiment of the present invention can easily and interestingly switch the mobile terminal to the remote controller after the digital television receiving terminal has continued to play the online video being played by the mobile terminal, which is convenient to the user and improves the experience of the user.

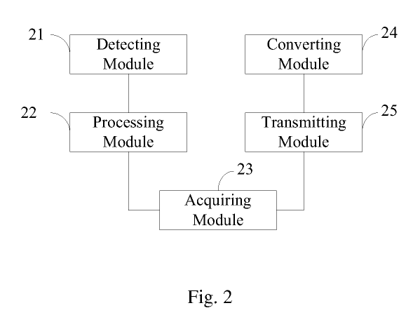

Referring to FIG. 2, FIG. 2 is a block diagram of an embodiment of a mobile terminal.

The mobile terminal provided by the invention includes:

The mobile terminal provided in an embodiment of the present invention includes:

a detecting module 21 for detecting a swinging state of a user; and

a processing module 22 for sending a playing instruction corresponding to a current online playing video to a digital television receiving terminal when the swinging state matches a predetermined rule and switching the current working state to the remote controller state.

Furthermore, the detecting module 21 is also configured to detect a swinging direction and/or swinging amplitude of the user.

Furthermore, the processing module 22 is also configured to switch the current working state to the remote controller state when the swinging direction and/or the swinging amplitude match the predetermined rule.

Furthermore, in detail, the processing module 22 is configured to transfer a currently running program into the background or stop the currently running program, and invokes a remote controller program to provide a virtual remote controller interface when the swinging state matches the predetermined rule.

Furthermore, in detail, the processing module 22 is configured to switch a keyboard input mode to a remote controller input mode when the swinging state matches the predetermined rule.

Furthermore, the mobile terminal also includes:

an acquiring module 23 for acquiring a keyboard instruction input by the user when the swinging state matches the predetermined rule;

a converting module 24 for converting the keyboard instruction to a corresponding remote controlling instruction according to the predetermined rule;

a transmitting module 25 for transmitting the remote controlling instruction.

Furthermore, in detail, the transmitting module 25 is configured to transmit the remote controlling command via the infrared and/or Bluetooth, and/or Wi-Fi.

In this embodiment, the detecting module 21 can be a vector sensor. The vector sensor can be a gyroscope and/or a gravity sensor, etc.

The detecting module 21 detects the swinging state of the user, and the swinging state can be a swinging direction and/or swinging amplitude.

When the swinging direction and/or the swinging amplitude of the user match the predetermined rule, the detecting module 21 determines that the user needs to play the video in the digital television receiving terminal. That is, the swinging action of the user needs to conform to a predetermined demand for avoiding a misoperation. When the swing action of the user conforms to the predetermined demand, the mobile terminal invokes a preset swinging control instruction.

When the detecting module 21 detects the swinging direction and/or the swinging amplitude of the user match the predetermined rule, the processing module 22 switches the current working state to the remote controller state. That is, when the swinging state of the user matches the predetermined rule, the processing module 22 determines the user is inputting a switching instruction of the working state.

For example, if the predetermined rule is the swinging actions which is swinging toward left first and then right, when the detecting module 21 detects the swinging action of the user matches the said condition, the detecting module 21 determines the user needs to switch the working state of the mobile terminal; It is understood that the rule can be predetermined rule can be fixed in advance or be reset in advance by the user, the predetermined rule also can be set as the swinging amplitude needs to reach a threshold value. When the detecting module 21 determines that the user needs to switch the working state of the mobile terminal, the processing module 22 switches the current working state to the remote controller state.

Furthermore, when the mobile terminal includes a touch screen, the processing module 22 can transfer the currently running program into the background or stop the currently running program according to the predetermined rule, and invokes a remote controlling program to provide the virtual remote controller interface. In this way, the user can execute a remote control by touching a key of the virtual remote controller interface via the touch screen. When the mobile terminal includes a physical keyboard, the processing module 22 switches an input mode of the physical keyboard to an input mode of the remote controller. In this way, when the user presses one key of the keyboard, the mobile terminal can convert a meaning of the pressed key on the keyboard to the corresponding remote controlling instruction according to the predetermined rule.

When the processing module 22 has switched the working state to the remote controller state, the mobile terminal converts the keyboard instruction to the remote controlling instruction and transmits the remote controlling instruction via the acquiring module 23, the converting module 24, and the transmitting module 25.

The digital television receiving terminal of this invention includes, but is not limited to, a set-top box, an Internet Protocol Television, a digital integrated television, a television phone, or a terminal which can receive the digital television.

The preferred embodiment mentioned above to further clarify the objectives, technical schemes, and advantages of the present invention. It is should be understood that, what is said above are only preferred examples of present invention, not intended to limit the present invention, any modifications, equivalent substitutions and improvements etc. made within the spirit and principle of the present invention, should be included in the protection range of the present invention. A scope of a right claimed by the present invention should be based on a scope applied by the present invention, but is not limited to the said embodiment.

1. a method for switching working state of a mobile terminal, the method comprising:
the mobile terminal detecting a swinging state of a user;
the mobile terminal sending a playing instruction used for a current online playing video to a digital television receiving terminal, and switching the working state of the mobile terminal to a remote controller state when the swinging state matches a predetermined rule; and
the digital television receiving terminal obtaining the playing video to play according to the playing instruction.

2. The method of claim 1, wherein the mobile terminal detecting the swinging state of a user, comprises:
the mobile terminal detecting a swinging direction and/or swinging amplitude of the user.

3. The method of claim 2, wherein the mobile terminal switching the working state to the remote controller state, comprises:
switching the current working state of the mobile terminal to the remote controller state when the swinging direction and/or the swinging amplitude of the user match the predetermined rule.

4. The method of claim 1, wherein the mobile terminal switching the working state to the remote controller state, comprises:
transferring a currently running program into the background or stopping the currently running program, and invoking a remote controller program to provide a virtual remote controller interface when the swinging state matches the predetermined rule.

5. The method of claim 1, wherein the mobile terminal switching the working state to the remote controller state, comprises:
switching an input mode of a physical keyboard to an input mode corresponding to a remote controller when the swinging state matches the predetermined rule.

6. The method of claim 1, wherein the method further comprises the following steps after the step of the digital television receiving terminal obtaining the playing video to play according to the playing instruction:
acquiring a key instruction of the user by the mobile terminal;
converting the key instruction to a corresponding remote controlling instruction according to the predetermined rule; and
transmitting the remote controlling instruction.

7. The method of claim 6, wherein the step of transmitting the remote controlling instruction, comprises:
the mobile terminal transmitting the remote controlling instruction via the infrared and/or Bluetooth, and/or Wi-Fi.

8. The method of claim 6, wherein the method further comprises the following step after the step of the digital television receiving terminal obtaining the playing video to play according to the playing instruction:
executing a corresponding processing according to the remote controlling instruction by the digital television receiving terminal.

9. A mobile terminal, comprising:
a detecting module, for detecting a swinging state of a user; and
a processing module, for sending a playing instruction used for a current online playing video to a digital television receiving terminal when the swinging state matches a predetermined rule, and switching the working state of the mobile terminal to the remote controller state, to enable the digital television receiving terminal to obtain the playing video to play according to the playing instruction.

10. The mobile terminal of claim 9, wherein the detecting module is also configured to detect a swinging direction and/or swinging amplitude of the user.

11. The mobile terminal of claim 10, wherein the processing module is also configured to switch the current working state to the remote controller state when the swinging direction and/or the swinging amplitude match the predetermined rule.

12. The mobile terminal of claim 9, wherein the processing module is configured to transfer a currently running program into the background or stop the currently running program and invokes a remote controller program to provide a virtual remote controller interface when the swinging state matches the predetermined rule.

13. The mobile terminal of claim 9, wherein the processing module is configured to switch an input mode of a physical keyboard to an input mode corresponding to a remote controller when the swinging state matches the predetermined rule.

14. The mobile terminal of claim 9, further comprising:
an acquiring module for acquiring a key instruction input by the user when the swinging state matches the predetermined rule;
a converting module for converting the key instruction to a corresponding remote controlling instruction according to the predetermined rule; and
a transmitting module for transmitting the remote controlling instruction.

15. The mobile terminal of claim 14, wherein the transmitting module is configured to transmit the remote controlling instruction via the infrared and/or Bluetooth, and/or Wi-Fi.

16. A switching system for switching working state of a mobile terminal, the switching system, comprising:
a mobile terminal, for detecting a swinging state of a user by a vector sensor, and sending a playing instruction used for a current online playing video to a digital television receiving terminal and switching the working state of the mobile terminal to a remote controller state when the swinging state matches a predetermined rule; and
a digital television receiving terminal, for obtaining the playing video to play according to the playing instruction.

17. (canceled)

18. The system of claim 16, wherein the mobile terminal comprises a detecting module, the detecting module is configured to detect a swinging direction and/or swinging amplitude of the user.

19. The system of claim 18, wherein the mobile terminal also comprises a processing module, the processing module is also configured to switch the current working state to the remote controller state when the swinging direction and/or the swinging amplitude match the predetermined rule.

20. The system of claim 19, wherein the processing module is configured to transfer a currently running program into the background or stop the currently running program and invokes a remote controller program to provide a virtual remote controller interface when the swinging state matches the predetermined rule.

21. The system of claim 19, wherein the mobile terminal further comprises:
an acquiring module for acquiring a key instruction input by the user when the swinging state matches the predetermined rule;
a converting module for converting the key instruction to a corresponding remote controlling instruction according to the predetermined rule; and
a transmitting module for transmitting the remote controlling instruction.
